(19) United States
(12) Patent Application Publication
(10) Pub. No.: US 2013/0157096 A1
(43) Pub. Date: Jun. 20, 2013

(54) NON-AQUEOUS ELECTROLYTE SECONDARY BATTERY AND METHOD FOR PRODUCING THE SAME

(71) Applicants: Yasushi Nakagiri, Tokushima (JP); Hiroaki Furuta, Osaka (JP); Yasuhiko Hina, Tokushima (JP); Yuji Yokoyama, Osaka (JP); Shinpei Yamagami, Tokushima (JP); Akira Nagasaki, Osaka (JP); Norihiro Yamamoto, Hyogo (JP)

(72) Inventors: Yasushi Nakagiri, Tokushima (JP); Hiroaki Furuta, Osaka (JP); Yasuhiko Hina, Tokushima (JP); Yuji Yokoyama, Osaka (JP); Shinpei Yamagami, Tokushima (JP); Akira Nagasaki, Osaka (JP); Norihiro Yamamoto, Hyogo (JP)

(73) Assignee: Panasonic Corporation, Osaka (JP)

(21) Appl. No.: 13/820,743

(22) PCT Filed: Sep. 16, 2011
(86) PCT No.: PCT/JP2011/005257

§ 371 Date: Mar. 4, 2013

(30) Foreign Application Priority Data
Sep. 28, 2010 (JP) 2010-216448
Sep. 28, 2010 (JP) 2010-216449
Dec. 16, 2010 (JP) 2010-280151
Mar. 28, 2011 (JP) 2011-069234

(51) Int. Cl. H01M 10/0587

(52) U.S. Cl. CPC H01M 10/0587
USPC 429/94; 264/104

(57) ABSTRACT

Disclosed is a non-aqueous electrolyte secondary battery including: a spirally-wound electrode group including a continuous first electrode, a continuous second electrode, and a continuous separator interposed between the first electrode and the second electrode; and a non-aqueous electrolyte. The first electrode includes a sheet-like first current collector, and a first active material layer formed on a surface of the first current collector; and the second electrode includes a sheet-like second current collector, and a second active material layer formed on a surface of the second current collector. In the electrode group, the winding terminal end of the first electrode faces the second electrode on the further outer peripheral side, with the separator interposed therebetween. The facing site of the second electrode where the second electrode faces the winding terminal end of the first electrode is reinforced with a reinforcing component for supplementing the thickness of the second electrode.

### TECHNICAL FIELD

The present invention relates to a non-aqueous electrolyte secondary battery including a spirally-wound electrode group which includes a continuous first electrode, a continuous second electrode, and a continuous separator interposed between the first electrode and the second electrode, and specifically relates to an improvement of the electrode group.

### BACKGROUND ART

In recent years, electronic devices are rapidly becoming more portable and cordless. For use as a power source for such devices, there is an increasing demand for small-size and light-weight secondary batteries with high energy density. Moreover, characteristics such as high output performance, durability over a long period of time, and safety are required not only for small-size secondary batteries for consumer use, but also for large-size secondary batteries for use in power storage apparatus and electric vehicles. Among secondary batteries, non-aqueous electrolyte secondary batteries with high voltage and high energy density are being developed actively.

Non-aqueous electrolyte secondary batteries represented by lithium ion secondary batteries have, for example, positive and negative electrodes each having a sheet-like current collector and an active material or material mixture layer formed thereon. These electrodes (electrode plates) are wound with a separator interposed therebetween, forming an electrode group. The electrode group is inserted into a battery case together with a non-aqueous electrolyte. With respect to lithium ion secondary batteries having such a structure, developments are made for the purpose of achieving a further higher energy density, such as increasing the density by compressing the material mixture layer, and reducing the thickness of a metal foil used as the current collector. Under these circumstances, it is regarded as important to prevent a breakage of the electrode plate caused by the tension applied thereto when compressing the material mixture layer or winding the electrode plates.

Patent Literature 1 specifies the ratio of a material mixture packing density in a portion where the material mixture layer is formed only on one surface of the current collector, to a material mixture packing density in a portion where the material mixture layer is formed on both surfaces of the current collector. Patent Literature 1 teaches that this can be used for preventing a breakage of the electrode plate when compressing the material mixture layer or winding the electrode plates, and avoiding a separation of the material mixture layer.

Patent Literature 2 suggests, as a proposal for preventing a breakage of the separator caused by the tension of winding the electrode plates, that the terminal end of the electrode plate be shaped to have a tapered cross section. By doing this, the thickness of the material mixture layer can be gradually reduced so that a great difference in thickness will not occur at the terminal end of the winding of the electrode plate.

Although not for preventing a breakage of the electrode plate or separation of the material mixture layer, Patent Literature 3 proposes that an insulating material with heat resistance be bonded onto the current collector of the positive electrode in the innermost layer. Patent Literature 3 teaches that this can suppress the occurrence of internal short circuits caused by contact between the positive and negative electrodes due to contraction of the separator in the innermost layer.

### CITATION LIST

### Patent Literature

[PTL 1] Japanese Laid-Open Patent Publication No. 2009-252349
[PTL 2] Japanese Laid-Open Patent Publication No. 2009-252503
[PTL 3] Japanese Laid-Open Patent Publication No. 2004-241170

### SUMMARY OF INVENTION

### Technical Problem

However, even though a breakage of the electrode plate when compressing the material mixture layer or winding the electrode plates can be avoided by following the proposal of Patent Literature 1, if the battery is repetitively charged and discharged rapidly in a high temperature environment, a breakage would occur in the electrode plate on the outer peripheral side of the electrode group, and the resultant increased resistance due to the breakage would cause the capacity to decrease. Moreover, if the breakage of the electrode plate proceeds until the electrode plate is completely severed, electrical conduction is lost, and capacity would be severely reduced.

In general, in lithium ion batteries, in association with migration of lithium ions between the positive and negative electrodes during charge and discharge, the electrode plate having absorbed lithium ions therein expands, while the electrode plate having released lithium ions therefrom contracts. As a result, the magnitude and direction of the tension applied to the electrode plates when the battery is produced will change as the charge and discharge are repeated.

In view of the above, the present inventors have conducted intensive studies on the cause of a breakage which occurs in the electrode plate on the outer peripheral side of the electrode group. The result found that the occurrence of an electrode plate breakage on the outer peripheral side of the electrode group is concentrated at a position overlapping the terminal end of another electrode plate with which the broken electrode plate faces on the inner side thereof. In other words, the abovementioned electrode plate breakage is caused by a difference in thickness due to the presence of the terminal end of the electrode plate on the inner side. Specifically, said difference in thickness generates a tension in the electrode plate on the outer peripheral side, and the tension changes continuously during repetitive charge and discharge. As a result, metal fatigue occurs in the current collector, which causes an electrode plate breakage. Particularly when rapid charge and discharge are repeated in a high temperature environment, the aforementioned changes in tension become more significant. Accordingly, the occurrence of an electrode plate breakage increases.

In order to cope with the problem as discussed above, if the terminal end portion of the electrode plate is shaped to have a tapered cross section as proposed by Patent Literature 2, the material mixture is likely to be separated from the current collector in the portion where the thickness of the material mixture layer is small. This would result in reduced productivity and would cause internal short circuits due to the separated material mixture layer having entered between the electrode plates. Even if an insulating material is bonded onto the current collector in the innermost layer as proposed by Patent Literature 3, the effect to suppress the electrode plate breakage on the outer peripheral side cannot be expected.

The present invention is made in view of the above problems, and intends to provide a non-aqueous electrolyte secondary battery in which an electrode plate breakage is unlikely to occur even when used under such conditions that rapid charge and discharge are repeated in a high temperature environment, and which has excellent cycle characteristics.

### Solution to Problem

One aspect of the present invention relates to a non-aqueous electrolyte secondary battery including: a spirally-wound electrode group including a continuous first electrode, a continuous second electrode, and a continuous separator interposed between the first electrode and the second electrode; and a non-aqueous electrolyte.

The first electrode includes a sheet-like first current collector, and a first active material layer (a first material mixture layer) formed on a surface of the first current collector.

The second electrode includes a sheet-like second current collector, and a second active material layer (a second material mixture layer) formed on a surface of the second current collector.

A winding terminal end of the first electrode faces the second electrode on the further outer peripheral side, with the separator interposed therebetween.

A facing site of the second electrode where the second electrode faces the winding terminal end of the first electrode is reinforced with a reinforcing component for supplementing the thickness of the second electrode.

For example, the above electrode group is configured such that an electrode-plate terminal end of one electrode plate of positive and negative electrodes on the outer peripheral side is covered with the other electrode plate on the further outer peripheral side. The other electrode plate is provided with a reinforcing component, at at least a position where it covers the electrode-plate terminal end.

Alternatively, the other electrode plate is provided with a reinforcing component, at a position where it covers the electrode-plate terminal end and on a surface not facing the electrode-plate terminal end.

Alternatively, the separator is provided on the outer periphery of the other electrode plate, and on the outer surface of the separator, a reinforcing component is provided so as to correspond to the position where the other electrode plate covers the electrode-plate terminal end.

In another aspect of the present invention, the second electrode includes a one-surface active-material-layer-free portion where the second active material layer is not formed on the outer peripheral side, and a both-surface active-material-layer-free portion where the second active material layer is not formed both on the outer peripheral side and on the inner peripheral side.

The one-surface active-material-layer-free portion includes the facing site.

The reinforcing component reinforces also a boundary between the one-surface active-material-layer-free portion and the both-surface active-material-layer-free portion.

For example, in one of the positive and negative electrodes that constitutes the outermost periphery of the electrode group, a region from the longitudinal end on the outer peripheral side to a predetermined position on the inner peripheral side is a both-surface current-collector-exposed portion where the material mixture layer is not provided on both surfaces, and a region continued from the both-surface current-collector-exposed portion to a predetermined position on the further inner peripheral side is a one-surface current-collector-exposed portion where the material mixture layer is provided on one surface on the inner side only.

At least part of the boundary between the both-surface current-collector-exposed portion and the one-surface current-collector-exposed portion is covered with a reinforcing component from the outer peripheral side.

Another aspect of the present invention is a method for producing a non-aqueous electrolyte secondary battery, the method comprising the steps of:

(a) preparing a continuous first electrode including a sheet-like first current collector, and a first active material layer formed on a surface of the first current collector;

(b) preparing a continuous second electrode including a sheet-like second current collector, and a second active material layer formed on a surface of the second current collector; and

(c) spirally winding the first electrode and the second electrode, with a continuous separator interposed therebetween, thereby to form an electrode group.

The first electrode and the second electrode are wound such that a winding terminal end of the first electrode faces the second electrode on the further outer peripheral side, with the separator interposed therebetween.

A facing site of the second electrode where the second electrode faces the winding terminal end of the first electrode is reinforced in advance with a reinforcing component for supplementing the thickness of the second electrode.

Yet another aspect of the present invention is a method for producing a non-aqueous electrolyte secondary battery, the method comprising the steps of:

(a) preparing a continuous first electrode including a sheet-like first current collector, and a first active material layer formed on a surface of the first current collector;

(b) preparing a continuous second electrode including a sheet-like second current collector, and a second active material layer formed on a surface of the second current collector; and

(c) spirally winding the first electrode and the second electrode, with a continuous separator interposed therebetween, thereby to form an electrode group.

The first electrode and the second electrode are wound such that a winding terminal end of the first electrode faces the second electrode on the further outer peripheral side, with the separator interposed therebetween, and then, a facing site of the second electrode where the second electrode faces the winding terminal end of the first electrode is reinforced with a reinforcing component for supplementing the thickness of the second electrode.

For example, the production method of a non-aqueous electrolyte secondary battery according to the present invention includes processes of: forming a positive electrode material mixture layer on a surface of a positive electrode current collector, to prepare a positive electrode; forming a negative electrode material mixture layer on a surface of a negative electrode current collector, to prepare a negative electrode; and winding the positive electrode and the negative electrode with a separator interposed therebetween, to form a spirally-wound electrode group. The process of preparing either the positive electrode or the negative electrode includes a step of forming a reinforcing component on the electrode plate. The process of forming an electrode group includes a step of arranging electrode plates such that an outer-peripheral-side electrode-plate terminal end of one of the positive and negative electrodes is covered with the other electrode plate. In the step of arranging the other electrode plate, the reinforcing component is arranged at a portion overlapping the electrode-plate terminal end and on a surface not facing the electrode-plate terminal end. By employing such production method, a battery in which an electrode plate breakage is unlikely to occur can be produced continuously in a more efficient manner, without the necessity of adding any new process.

Another production method of a non-aqueous electrolyte secondary battery according to the present invention includes a process of winding a positive electrode including a positive electrode current collector and a positive electrode material mixture layer formed thereon, and a negative electrode including a negative electrode current collector and a negative electrode material mixture layer formed thereon, with a separator interposed therebetween, to form a spirally-wound electrode group. The process of forming an electrode group includes: a step of arranging electrode plates such that an outer-peripheral-side electrode-plate terminal end of one of the positive and negative electrodes is covered with the other electrode plate; and a step of providing a reinforcing component in the other electrode plate in a portion overlapping the electrode-plate terminal end. By employing such production method, the reinforcing component can be positioned more accurately.

In the other electrode plate above, in the portion overlapping the electrode-plate terminal end, the reinforcing component is preferably provided on a surface not facing the electrode-plate terminal end.

Yet another production method of a non-aqueous electrolyte secondary battery according to the present invention includes a process of winding a positive electrode including a positive electrode current collector and a positive electrode material mixture layer formed thereon, and a negative electrode including a negative electrode current collector and a negative electrode material mixture layer formed thereon, with a separator interposed therebetween, to form a spirally-wound electrode group. The process of forming an electrode group includes: a step of arranging electrode plates such that an electrode-plate terminal end on the outer peripheral side of one of the positive and negative electrodes is covered with the other electrode plate; a step of arranging the separator so as to cover the other electrode plate; and a step of providing a reinforcing component on the outer surface of the separator, at a position corresponding to the position where the other electrode plate covers the electrode-plate terminal end. By employing such production method, pressure is reliably applied from outside to the other electrode plate.

### Advantageous Effects of Invention

According to the present invention, it is possible to suppress the electrode plate breakage even when the non-aqueous electrolyte secondary battery is rapidly charged and discharged repetitively in a high temperature environment, or when the battery is overcharged. It is therefore possible to provide a non-aqueous electrolyte secondary battery having excellent cycle characteristics.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 A partially cut-away oblique view of a structure of a non-aqueous electrolyte secondary battery according to one embodiment of the present invention

FIG. 2 A partially exploded cross-sectional view of an electrode group of the non-aqueous electrolyte secondary battery of FIG. 1

FIG. 3 A plane view of the partially-exploded electrode group in FIG. 2, as seen from the outer peripheral side of the electrode group

FIG. 4 A partially exploded cross-sectional view of an electrode group of a non-aqueous electrolyte secondary battery, illustrating one exemplary reinforcing component of the present invention

FIG. 5 A partially exploded cross-sectional view of an electrode group of a non-aqueous electrolyte secondary battery according to another embodiment of the present invention

FIG. 6 A partially exploded cross-sectional view of an electrode group of a non-aqueous electrolyte secondary battery according to yet another embodiment of the present invention

FIG. 7 A plane view of a partially-exploded electrode group of a variant of the above embodiments, as seen from the outer peripheral side of the electrode group

FIG. 8 A plane view of a partially-exploded electrode group of another variant of the above embodiments, as seen from the outer peripheral side of the electrode group

### DESCRIPTION OF EMBODIMENTS

In one embodiment of the present invention, a non-aqueous electrolyte secondary battery includes: a spirally-wound electrode group including a continuous first electrode, a continuous second electrode, and a continuous separator interposed between the first electrode and the second electrode; and a non-aqueous electrolyte. The first electrode includes a sheet-like first current collector, and a first active material layer formed on a surface of the first current collector. The second electrode includes a sheet-like second current collector, and a second active material layer formed on a surface of the second current collector.

The winding terminal end of the first electrode faces the second electrode on the further outer peripheral side, with the separator interposed therebetween. The facing site of the second electrode where the second electrode faces the winding terminal end of the first electrode is reinforced with a reinforcing component for supplementing the thickness of the second electrode.

In the non-aqueous electrolyte secondary battery of the present invention configured as above, even when the second electrode at the outermost periphery undergoes great changes in tension due to the presence of a difference in thickness at the winding terminal end of the first electrode on the inner side thereof and due to repetitive charge and discharge, the facing site is less likely to expand and contract, and the strength of the electrode is ensured. As such, the occurrence of electrode breakage can be suppressed. Here, the reinforcing component can be directly provided on the facing site so as to contact therewith.

In the case where the facing site is an active-material-layer-free portion where the second active material layer is not formed on the outer peripheral side, the thickness of the facing site is comparatively small, and accordingly, the strength thereof is small. Therefore, the significance of providing a reinforcing component in the active-material-layer-free portion, to supplement the thickness of the second electrode is great. In this case, by providing the reinforcing component directly on the second current collector so that it is provided on the outer peripheral side of the facing site, the facing site can be effectively reinforced.

Examples of the reinforcing component are specifically described below.

In the case where an area including the facing site, of the second electrode at the outermost periphery of the electrode group is an active-material-layer-free portion where the second active material layer is not formed at least on the outer peripheral side, the reinforcing component may be composed of a second active material layer partially formed only on the outer peripheral side of the facing site within the active-material-layer-free portion. In other words, the second electrode is formed such that: the facing site is an active-material-layer-formed portion where the second active material layer is formed at least on the outer peripheral side; the active-material-layer-formed portion is present between the active-material-layer-free portions where the second active material layer is not formed at least on the outer peripheral side; and the second active material layer formed on the outer peripheral side of the active-material-layer-formed portion comprises the reinforcing component. By composing the reinforcing component of the second active material layer as above, the second electrode can be efficiently reinforced without adding any new process for forming a reinforcing component, in the process of preparing the electrode.

Alternatively, the reinforcing component may be composed of a tape including a base sheet and an adhesive provided on at least one surface of the base sheet. This can more reliably reinforce a portion of the second current collector where the aforementioned breakage due to metal fatigue might occur. In view of the safety, the base sheet is preferably resistant to denaturation at 120° C. The “denaturation” of the base sheet refers to at least one of thermal deformation, melting, and thermal shrinkage of the base sheet. An example of the base sheet is a resin sheet made of, for example, polypropylene, polyester, polyphenylene sulfide, polyimide, Kapton (registered trademark), or polytetrafluoroethylene (PTFE). Another example of the base sheet is a glass sheet.

The aforementioned tape may be a metal tape in which the base sheet includes a metal foil such as aluminum foil or copper foil. In this case, by using the same material for the metal foil and for the second current collector, they can have the same thermal expansion coefficient. As a result, the reinforcing component becomes less likely to separate from the electrode. Moreover, since the thermal conductivity of the metal tape is high, the heat dissipation from the electrode group is not impaired.

Alternatively, the reinforcing component may be composed of a thick portion where the thickness of the second current collector is partially increased at the facing site. This allows the reinforcing component to be provided in an easy and simple manner, without using any additional member.

In the case where the separator is arranged on the further outer peripheral side of the facing site, the reinforcing component may be provided on the separator away from the second electrode, at a position facing the facing site. In this configuration, against the changes in tension during repetitive charge and discharge, pressure is applied to the facing site of the second electrode from outside the separator. Therefore, by this configuration also, the expansion and contraction of the second electrode at the facing site can be suppressed. As a result, the strength of the electrode can be ensured, and the effect similar to the above can be obtained. In this case also, the reinforcing component may be provided on the outer peripheral side of the separator.

In another embodiment of the present invention, the second electrode includes a one-surface active-material-layer-free portion where the second active material layer is not formed on the outer peripheral side, and a both-surface active-material-layer-free portion where the second active material layer is not formed both on the outer and inner peripheral sides. The both-surface active-material-layer-free portion is adjacent to the one-surface active-material-layer-free portion. The one-surface active-material-layer-free portion includes the facing site. The reinforcing component is provided so as to reinforce also a boundary between the one-surface active-material-layer-free portion and the both-surface active-material-layer-free portion.

The present inventors have further conducted intensive studied to solve the problem of an electrode breakage. As a result, they found that an electrode breakage in a non-aqueous electrolyte secondary battery in an overcharged state is likely to occur also at the boundary between the one-surface active-material-layer-free portion and the both-surface active-material-layer-free portion of the electrode at the outermost periphery. This is presumably attributed to the following reasons.

When a lithium ion secondary battery is continuously charged at a constant current until it is overcharged, lithium ions migrate to the negative electrode, and the negative electrode having received lithium ions expands. This increases the tension in the positive and negative electrodes constituting the electrode group. As the amount of charged electricity further increases, the negative electrode becomes incapable of receiving lithium ions as “ions”, causing lithium metal to deposit on the surface of the negative electrode. As a result, the aforementioned tension further increases. Particularly, the boundary between the one-surface active-material-layer-free portion and the both-surface active-material-layer-free portion is a boundary between a portion where the active material layer is present only on one surface of the current collector and a portion where the active material layer is not present at all, with both surfaces of the current collector being exposed. Therefore, the distortion of the electrode due to the aforementioned tension is severer, and an electrode breakage is more likely to occur.

By reinforcing a predetermined area including the above boundary (a boundary area) with the reinforcing component, the expansion and contraction of the boundary area can be suppressed even when the tension continuously changes greatly due to the overcharged state, and the strength of the electrode can be ensured, which suppresses the occurrence of burrs due to an electrode breakage. It is therefore unlikely to happen that the resultant burrs cause internal short circuits, to make the battery overheated to an abnormally high temperature.

In other words, it is possible to prevent not only an electrode breakage due to rapid charge and discharge repeated in a high temperature environment but also an electrode breakage attributed to overcharging of the non-aqueous electrolyte secondary battery, at the same time.

The reinforcing component may be provided on at least one widthwise end portion of the second electrode. An electrode breakage tends to occur starting from an end portion in the width direction. As such, simply by reinforcing the end portion, an electrode breakage can be effectively prevented.

There are roughly two ways for producing a non-aqueous electrolyte secondary battery as mentioned above. One is a method for producing a non-aqueous electrolyte secondary battery including the steps of: (a) preparing a continuous first electrode including a sheet-like first current collector, and a first active material layer formed on a surface of the first current collector; (b) preparing a continuous second electrode including a sheet-like second current collector, and a second active material layer formed on a surface of the second current collector; and (c) spirally winding the first electrode and the second electrode, with a continuous separator interposed therebetween, thereby to form an electrode group. The first electrode and the second electrode are wound such that a winding terminal end of the first electrode faces the second electrode on the further outer peripheral side, with the separator interposed therebetween. The facing site of the second electrode where the second electrode faces the winding terminal end of the first electrode is reinforced in advance with a reinforcing component for supplementing the thickness of the second electrode. By using this method, a battery including an electrode group in which an electrode breakage is unlikely to occur can be produced without particularly adding another process to the conventional electrode group production line. Therefore, the takt time in the non-aqueous electrolyte secondary battery production is easily prevented from being lengthened.

The other is a method in which the first electrode and the second electrode are wound such that the winding terminal end of the first electrode faces the second electrode on the further outer peripheral side, with the separator interposed therebetween, and then, the facing site of the second electrode where the second electrode faces the winding terminal end of the first electrode is reinforced with a reinforcing component for supplementing the thickness of the second electrode. By using this method, the reinforcing component can be positioned more accurately, at a position suitable for suppressing an electrode breakage. Therefore, the occurrence of an electrode breakage can be more reliably prevented.

Description is given below of the non-aqueous electrolyte secondary battery of the present invention, with reference to the drawings appended hereto.

### Embodiment 1

FIG. 1 is a partially cut-away oblique view of an internal structure of a cylindrical lithium ion secondary battery according to one embodiment of the present invention. The lithium ion secondary battery of FIG. 1 includes an electrode group 14 formed by winding a belt-like positive electrode 5 and a belt-like negative electrode 6, which are electrodes (electrode plates), with a separator 7 interposed therebetween. The electrode group 14 is accommodated in a bottomed cylindrical battery case 1 made of metal, together with a non-aqueous electrolyte (not shown).

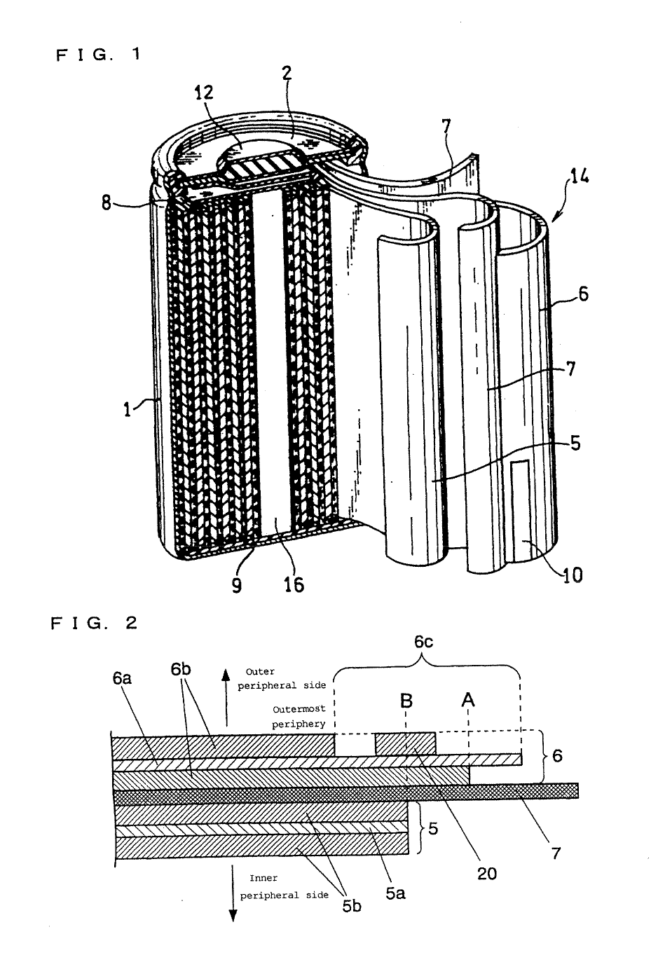

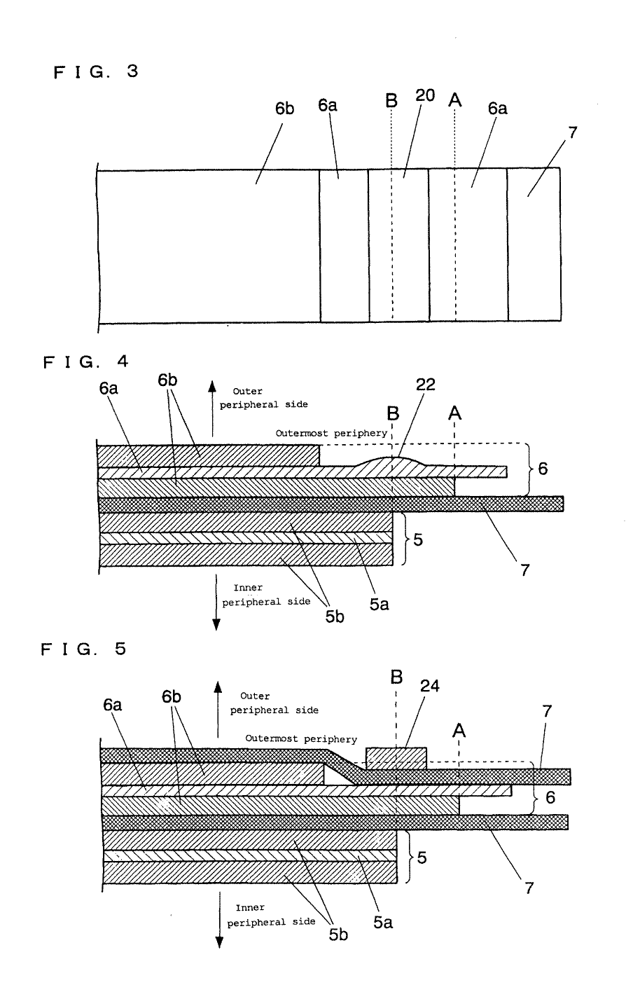

FIG. 2 is an enlarged cross-sectional view of the end portions of winding of the electrodes on the outer peripheral side of the electrode group 14. As shown in the figure, in the battery as illustrated, the positive and negative electrodes 5 and 6 are wound such that the negative electrode 6 (an exemplary of the second electrode in the illustrated battery) is positioned on the further outer peripheral side of the positive electrode 5 (an exemplary of the first electrode). The positive electrode 5 includes a positive electrode current collector 5a made of a metal foil, and a positive electrode active material layer (positive electrode material mixture layer) 5b formed on a surface thereof. The negative electrode 6 includes a negative electrode current collector 6a made of a metal foil, and a negative electrode active material layer (negative electrode material mixture layer) 6b formed on a surface thereof. Each of the positive and negative electrodes 5 and 6 has a winding start end on the inner peripheral side of the electrode group 14, and a winding terminal end on the outer peripheral side of the electrode group 14.

Positioned at the outermost periphery of the electrode group 14 is the negative electrode 6. The negative electrode 6 is also wound on the outer peripheral side of the positive electrode 5, so as to cover a winding terminal end B of the positive electrode 5. At the outermost periphery of the electrode group 14, the negative electrode 6 has an active-material-layer-free portion 6c where the negative electrode active material layer 6b is not formed at least on the outer peripheral side of the negative electrode current collector 6a. A reinforcing component 20 is provided at a site (facing site) facing the winding terminal end B of the positive electrode 5 with the separator 7 interposed therebetween, within the active-material-layer-free portion 6c. The reinforcing component 20 is specifically described below.

The reinforcing component 20 may be provided directly on the negative electrode 6 so as to contact the facing site of the negative electrode 6, or alternatively, may be provided away from the facing site of the negative electrode 6 (for example, with a separator interposed therebetween). Alternatively, the reinforcing component 20 may be provided on the inner peripheral side, or alternatively on the outer peripheral side of the facing site. Particularly when the reinforcing component 20 is provided (for example, by pasting) directly on the negative electrode 6 on the outer peripheral side of the facing site, the facing site is more effectively reinforced in many cases.

The reinforcing component 20 can be formed by, for example, partially forming the negative electrode active material layer 6b in the active-material-layer-free portion 6c. The negative electrode active material layer 6b serving as the reinforcing component 20 preferably has the same thickness as the negative electrode active material layer 6b in the other portion. By doing this, the reinforcing component 20 can be formed through the same process as that of forming the negative electrode active material layer 6b in the other portion. As a result, the electrode can be efficiently produced without adding any new process.

The reinforcing component 20 may be a tape, specifically, a heat resistant tape. By configuring like this, a portion where a breakage due to metal fatigue of the negative electrode current collector 6a might occur can be reinforced reliably. The heat resistant tape is preferably resistant to denaturation even at 120° C., in view of the safety. The “denaturation” of the tape refers to thermal deformation, melting, thermal shrinkage, and the like of the tape. Examples of the heat resistant tape include a polypropylene tape, polyester tape, polyphenylene sulfide tape, polyimide tape, glass adhesive tape, aluminum foil adhesive tape, copper foil adhesive tape, Kapton (registered trademark) tape, and PTFE tape.

Another example of the heat resistant tape is a metal tape formed by integrating a metal foil and an adhesive. In this case, by using the same material for the metal foil of the metal tape and for the negative electrode current collector 6a, they can have the same thermal expansion coefficient. As a result, the reinforcing component 20 becomes less likely to separate from the negative electrode 6. Moreover, since the thermal conductivity of the metal tape is high, the above effect can be achieved without impairing the heat dissipation from the electrode group.

Alternatively, the reinforcing component can be formed by partially increasing the thickness of the negative electrode current collector 6a. FIG. 4 is an exemplary configuration in which a reinforcing component 22 is formed by partially increasing the thickness of the negative electrode current collector 6a. When configured like this, the reinforcing component 22 can be obtained simply by using, in the electrode preparation process, the negative electrode current collector 6a provided with a thick portion. Therefore, an electrode can be efficiently produced, without the necessity of adding any new process. With regard to the method of partially increasing the thickness of the current collector, for example, in the case of the negative electrode current collector, the thickness can be partially increased in the production process of an electrolytic copper foil, in an easy manner by periodically increasing the current density (quantity of electricity conducted) for electrodepositing a foil on a rotating drum only at a portion corresponding to the reinforcing component 22.

A positive electrode lead terminal 8 is connected electrically to the positive electrode 5, and a negative electrode lead terminal 10 is connected electrically to the negative electrode 6. The electrode group 14 is inserted into the battery case 1 together with a lower insulating plate 9, with the positive electrode lead terminal 8 being extended upward outside. To the end of the positive electrode lead terminal 8, a sealing plate 2 is welded. The sealing plate 2 is provided with a positive electrode external terminal 12, and a safety mechanism comprising a PTC element and an anti-explosion valve (not shown).

The lower insulating plate 9 is disposed between the bottom of the electrode group 14 and the negative electrode lead terminal 10 extended downward from the electrode group 14. The negative electrode lead terminal 10 is welded to the inner bottom surface the battery case 1. An upper insulating ring (not shown) is mounted on the top of the electrode group 14, and a circumferential portion immediately above the upper insulating ring of the side wall of the battery case 1 is dented inwardly, to form an annular step portion. As a result, the electrode group 14 is held within the battery case 1. Subsequently, a predetermined amount of non-aqueous electrolyte is injected into the battery case 1, and the positive electrode lead terminal 8 is folded to be accommodated in the battery case 1. On the annular step portion, the sealing plate 2 provided with a gasket 13 around the periphery thereof is mounted. Thereafter, the opening end of the battery case 1 is clamped inwardly to seal the case. This completes the production of a cylindrical lithium ion secondary battery.

The electrode group 14 is formed by spirally winding around a winding core (not shown), the positive electrode 5, the separator 7, the negative electrode 6, and another separator 7 stacked in this order, and then removing the winding core. Specifically, the constituent elements (the positive electrode 5, negative electrode 6, and separator 7) of the electrode group 14 are stacked such that both longitudinal end portions of the two separators 7 are extended from both longitudinal ends of the positive and negative electrodes 5 and 6. The end portions of the separators 7 extended from one longitudinal end are held between a pair of winding cores disposed in parallel thereto, and in this state, the constituent elements of the electrode group 14 are wound. Several rounds from the start of winding (e.g. the 1st to 3rd rounds from the start) may be in such a state that only two separators 7 are wound. The portion in which only the separators 7 are wound is shown as a core portion 16 in FIG. 1.

The electrode winding structure as mentioned above is particularly useful in the case where an electrode group is formed by winding positive and negative electrodes including a large amount of positive or negative electrode active material packed therein, at high tension. For example, a high capacity 18650 cylindrical battery having a nominal capacity of 2000 mAh or more is produced to include the electrode group 14 having the aforementioned winding structure.

When positive and negative electrodes with an increased amount of active material packed therein are wound together with separators, the outer diameter of the resultant electrode group tends to increase. In order to insert such an electrode group in a bottomed case with a certain volume, the separators whose end portions on one side are held between a pair of winding cores must be wound at high tension together with the positive and negative electrodes. Winding at high tension increases the adhesion between the positive and negative electrodes and the separators.

When a cylindrical lithium ion secondary battery including electrodes wound at high tension is subjected to rapid charge and discharge repeated in a high temperature environment, breakage is likely to occur in the negative electrode 6 (particular, in the negative electrode current collector 6a) disposed at the outermost periphery of the electrode group 14, at a position facing the winding terminal end B of the positive electrode 5.

Although FIG. 1 illustrates a cylindrical battery, the present invention can be applied to a prismatic battery whose cross section perpendicular to the winding axis of the electrode group is a long oval. Moreover, although FIG. 1 illustrates an example in which the negative electrode 6 is disposed at the outermost periphery, the positive electrode 5 can be disposed at the outermost periphery with similar effects on the breakage of the positive electrode 5 disposed at the outermost periphery, by employing a similar configuration.

In a lithium ion secondary battery having the above structure, by providing the reinforcing component 20 or 22 in an area where the surface of the negative electrode current collector 6a is exposed at a site where the negative electrode 6 at the outermost periphery faces the winding terminal end B of the negative electrode 5, the negative electrode 6 can be effectively reinforced. This makes an electrode breakage unlikely to occur even when the tension applied to the electrodes is varied due to repetitive expansion and contraction of the electrodes during charge and discharge of the secondary battery.

In the following, each constituent element of the non-aqueous electrolyte secondary battery according to Embodiment 1 is described in more detail.

(Positive Electrode)

The positive electrode current collector 5a may be any known positive electrode current collector for a non-aqueous electrolyte secondary battery, such as a metal foil made of one or two or more selected from aluminum, aluminum alloy, stainless steel, titanium, and titanium alloy. The material of the positive electrode current collector may be selected appropriately in view of the processability, practical strength, adhesion with the positive electrode active material layer 5b, electron conductivity, corrosion resistance, and other factors. The thickness of the positive electrode current collector may be, for example, 1 to 100 μm. The thickness of the positive electrode current collector is preferably 10 to 50 μm.

The positive electrode active material layer 5b may contain, in addition to the positive electrode active material, a conductive agent, a binder, a thickener, and the like. The positive electrode active material may be, for example, a lithium-containing transition metal compound capable of receiving lithium ions as a guest. The lithium-containing transition metal compound is exemplified by a composite metal oxide of lithium and at least one metal selected from cobalt, manganese, nickel, chromium, iron, and vanadium. Examples of the composite metal oxide include LiCoO₂, LiMn₂O₄, LiCoₓNi₁₋ₓO₂ where 0<x<1, LiCo_{y}M_{1-y}O₂ where 0.6≦y<1, LiNi_{z}M_{1-z}O₂ where 0.6≦z<1, LiCrO₂, αLiFeO₂, and LiVO₂. In the above compositional formulae, M is at least one element selected from the group consisting of Na, Mg, Sc, Y, Mn, Fe, Co, Ni, Cu, Zn, Al, Cr, Pb, Sb, and B. Among them, Mg and Al are preferred. These positive electrode active materials may be used singly or in combination of two or more.

The binder is not particularly limited, and may be any binder that can be dispersed in a dispersion medium by kneading. Examples of the binder include fluorocarbon resin, rubbers, and acrylic polymer or vinyl polymer (e.g., a homo- or co-polymer of an acrylic monomer such as methyl acrylate or acrylonitrile, or of a vinyl monomer such as vinyl acetate). Examples of the fluorocarbon resin include polyvinylidene fluoride, a copolymer of vinylidene fluoride and hexafluoropropylene, and polytetrafluoroethylene. Examples of the rubbers include acrylic rubber, modified acrylonitrile rubber, and styrene-butadiene rubber (SBR). These binders may be used singly or in combination of two or more. The binder may be used in the form of dispersion in which the binder is dispersed in a dispersion medium.

Examples of the conductive agent include: carbon black, such as acetylene black, Ketjen black, channel black, furnace black, lamp black, and thermal black; graphites, such as natural graphite and artificial graphite; and conductive fibers, such as carbon fibers and metal fibers.

Examples of the thickener include ethylene-vinyl alcohol copolymer, and cellulose derivative (e.g., carboxymethyl cellulose and methylcellulose).

The dispersion medium is not particularly limited, and may be any dispersion medium in which the binder can be dispersed. Either an organic solvent or water (including warm water) may be used depending on the affinity of the binder to the dispersion medium. Examples of the organic solvent include: N-methyl-2-pyrrolidone; ethers, such as tetrahydrofuran; ketones, such as acetone, methyl ethyl ketone, and cyclohexanone; amides, such as N,N-dimethylformamide and dimethylacetamide; sulfoxides, such as dimethylsulfoxide; and tetramethylurea. These dispersion mediums may be used singly or in combination of two or more.

The positive electrode active material layer 5b can be formed by kneading a positive electrode active material, and as needed, a binder, a conductive agent, and a thickener, together with a dispersion medium to disperse them, thereby to prepare a material mixture in the form of slurry, and allowing the material mixture to adhere to the positive electrode current collector 5a. Specifically, the material mixture is applied onto a surface of the positive electrode current collector 5a by a known coating method, dried and then rolled as needed. A positive electrode active material layer is thus formed. The surface of the positive electrode current collector 5a includes a portion where the positive electrode active material layer 5b is not formed and the surface of the positive electrode current collector 5a is exposed. To this portion, a positive electrode lead is connected. The positive electrode preferably has excellent flexibility.

The material mixture can be applied using a known coater, such as a slit die coater, reverse roll coater, lip coater, blade coater, knife coater, gravure coater, or dip coater. The drying after application is preferably performed under the conditions approximate to natural drying. However, in view of the productivity, it is preferably performed at a temperature within the range of 70° C. to 200° C. for 10 minutes to 5 hours. The rolling of the positive electrode active material layer 5b can be performed by, for example, repeating rolling a few times with a roll press machine until a predetermined thickness is obtained, with the line pressure set at 1000 to 2000 kgf/cm (9.8 to 19.6 kN/cm). The line pressure may be changed, as needed, in the rolling.

In kneading into a material mixture in the form of slurry, for example, various dispersants, surfactants, and stabilizers may be added as needed.

The positive electrode active material layer 5b may be formed on one surface or both surfaces of the positive electrode current collector. In the case of using a lithium-containing transition metal compound as the positive electrode active material, the density of the positive electrode active material in the positive electrode active material layer 5b may be 3 to 4 g/ml, and is preferably 3.4 to 3.9 g/ml, and more preferably 3.5 to 3.7 g/ml.

The thickness of the positive electrode may be, for example, 70 to 250 μm, and is preferably 100 to 210 μm.

(Negative Electrode)

The negative electrode current collector 6a may be any known negative electrode current collector for a non-aqueous electrolyte secondary battery, such as a metal foil made of copper, copper alloy, nickel, nickel alloy, stainless steel, aluminum, or aluminum alloy. The negative electrode current collector is preferably a copper foil or a metal foil made of copper alloy, in view of the processability, practical strength, adhesion with the positive electrode active material layer 6b, electron conductivity, and other factors. The negative electrode current collector 6a may be of any form without particular limitation, and may be, for example, in the form of a rolled foil or an electrolytic foil, or in the form of a perforated foil, an expanded material, or a lath. The thickness of the negative electrode current collector 6a may be, for example, 1 to 100 μm. The thickness of the negative electrode current collector 6a is preferably 2 to 50 μm.

The negative electrode active material layer 6b may contain, in addition to the negative electrode active material, a conductive agent, a binder, a thickener, and the like. The negative electrode active material 6b may be a material having a graphite-like crystal structure capable of reversibly absorbing and releasing lithium ions, and is, for example, a carbon material, such as natural graphite, spherical or fibrous artificial graphite, non-graphitizable carbon (hard carbon), or graphitizable carbon (soft carbon). Particularly preferred is a carbon material having a graphite-like crystal structure in which the interplanar spacing (d002) between the (002) lattice planes is 0.3350 to 0.3400 nm. Further examples of the negative electrode active material include: silicon; silicon-containing compounds, such as silicide; lithium alloys and various alloy materials containing at least one selected from tin, aluminum, zinc, and magnesium.

An example of the silicon-containing compound is a silicon oxide SiO_{α} where 0.05<α<1.95. The value a is preferably 0.1 to 1.8, and more preferably 0.15 to 1.6. In the silicon oxide, silicon may be partially replaced with one element or two or more elements. Examples of such elements include B, Mg, Ni, Co, Ca, Fe, Mn, Zn, C, N, and Sn.

Examples of the binder, conductive agent, thickener, and dispersion medium include those listed for the positive electrode.

The negative electrode active material layer can be formed by any known method, without being limited to the above-exemplified coating method using together with a binder and the like. For example, it may be formed by depositing a negative electrode active material on a surface of the current collector by a vapor phase method such as vacuum vapor deposition, sputtering, or ion plating. Alternatively, it may be formed by the method similar to that of forming the positive electrode active material layer, using a material mixture in the form of slurry including a negative electrode active material, a binder, and as needed, a conductive material.

The negative electrode active material layer 6b may be formed on one surface or both surfaces of the negative electrode current collector 6a. In the case of using a carbon material as the negative electrode active material, the density of the active material in the negative electrode active material layer 6b may be 1.3 to 2 g/ml, and is preferably 1.4 to 1.9 g/ml, and more preferably 1.5 to 1.8 g/ml.

The thickness of the negative electrode 6 may be, for example, 100 to 250 μm, and is preferably 110 to 210 μm. The negative electrode preferably has flexibility.

(Separator)

The thickness of the separator may be selected from the range of, for example, 5 to 35 μm, and is preferably 10 to 30 μm, and more preferably 12 to 20 μm. When the thickness of the separator is too small, minor short circuits are likely to occur inside the battery. On the other hand, when the thickness of the separator is too large, it becomes necessary to reduce the thicknesses of the positive and negative electrodes, which may result in a reduced battery capacity.

The material of the separator may be a polyolefin-based material, or a combination of a polyolefin-based material and a heat resistant material. A polyolefin porous film commonly used as the separator has a so-called shutdown function that works when the battery temperature is elevated to a certain temperature, in which the polyolefin softens and closes the pores of the film, and the ion conductivity of the film is lost, to stop the battery reaction. However, if the battery temperature is further elevated even after the shutdown function starts working, meltdown occurs, that is, the polyolefin melts away. As result, a short circuit occurs between the positive electrode and the negative electrode. The shutdown function and the meltdown are dependent on the softening property and melting property of the resin constituting the separator. Therefore, for enhancing the shutdown function while effectively preventing the meltdown, a composite film being a combination of a polyolefin porous film and a heat resistant porous film is preferably used as the separator.

The polyolefin porous film may be, for example, a porous film of polyethylene, polypropylene, or ethylene-propylene copolymer. These resins may be used singly or in combination of two or more. A thermoplastic polymer other than the above may be used, as needed, in combination with polyolefin.

The polyolefin porous film may be a porous film made of polyolefin, or a woven or non-woven fabric made of polyolefin fibers. The porous film is formed by, for example, forming a molten resin into a sheet and uniaxially or biaxially stretching the sheet. The polyolefin porous film may be a porous film composed of one porous polyolefin layer or may include two or more porous polyolefin layers.

The heat resistant porous film may be a layer composed only of a heat resistant resin or an inorganic filler, or a mixture of a heat resistant resin and an inorganic filler.

Examples of the heat resistant resin include: aromatic polyamide (e.g., fully aromatic polyamide), such as polyarylate and aramid; polyimide resin, such as polyimide, polyamide-imide, polyetherimide, and polyester imide; aromatic polyester, such as polyethylene terephthalate; polyphenylene sulfide; polyether nitrile; polyether ether ketone; and polybenzimidazole. These heat resistant resins may be used singly or in combination of two or more. In view of the retention of non-aqueous electrolyte and the heat resistance, aramid, polyimide, and polyamide-imide are preferred as the heat resistant resin.

A specific example of the heat resistant resin is a resin having a heat deflection temperature of 260° C. or more as calculated under a load of 1.82 MPa, from the measurement of deflection temperature under load in accordance with the test method ASTM-D648 standardized by the American Society for Testing and Materials. The upper limit of the heat deflection temperature is not particularly limited; however, the heat deflection temperature is preferably about 400° C. or less, in view of the characteristics as the separator, and the pyrolysis of the resin. The higher the heat deflection temperature is, the more likely the shape of the separator is to be maintained even when, for example, the polyolefin porous film shrinks by heat. As such, by using the resin having a heat deflection temperature of 260° C. or more, the meltdown can be prevented even when the battery temperature is elevated to, for example, about 180° C. due to the heat stored during overheating, and a sufficiently high thermal stability can be achieved.

Examples of the inorganic filler include: metal oxides, such as iron oxide; ceramics, such as silica, alumina, titania, and zeolite; mineral-based fillers, such as talc and mica; carbon-based fillers, such as activated carbon and carbon fiber; nitrides, such as silicon nitride; glass fibers; glass beads; and glass flakes. The inorganic filler may be of any form without particular limitation, and may be, for example, in the form of particles or powder, in the form of fibers, in the form of flakes, or in the form of agglomerates. These inorganic filler may be used singly or in combination of two or more.

Alternatively, the heat resistant porous film may contain an inorganic filler so that the functions of the both can be combined. The ratio of the inorganic filler to 100 parts by weight of the heat resistant resin may be, for example, 50 to 400 parts by weight, and is preferably 80 to 300 parts by weight. The larger the amount of the inorganic filler is, the higher the hardness and friction coefficient of the heat resistant porous film are, and the less slippery the surface of the heat resistant porous film is.

The thickness of the heat resistant porous film may be 1 to 16 μm, and is preferably 2 to 10 μm, in view of the balance between the safety against internal short circuits and the electric capacity. When the thickness of the heat resistant porous film is too small, the effect to suppress the heat shrinkage of the polyolefin porous film in a high temperature environment is reduced. On the other hand, when the thickness of the heat resistant porous film is too large, the impedance of the heat resistant porous film increases because of its comparatively low porosity and ion conductivity, and the charge/discharge characteristics deteriorate.

In the case where the separator is a composite film comprising a polyolefin porous film and a heat resistant porous film, the thickness of each film may be 2 to 17 μm, and is preferably 3 to 10 μm. Since the heat resistant porous film is harder than the polyolefin porous film, the thickness of the polyolefin porous film is preferably larger than that of the heat resistant porous film. However, if the thickness of the polyolefin porous film is too large, it may happen that the polyolefin porous film shrinks greatly when the battery temperature is elevated, and the heat resistant porous film is pulled along therewith, causing the electrode lead to be partially exposed. The thickness of the polyolefin porous film may be 1.5 to 8 times as large as that of the heat resistant porous film, and is preferably 2 to 7 times, and more preferably 3 to 6 times as large as that of the heat resistant porous film.

The porosity in the polyolefin porous film (or the porous polyolefin layer) may be, for example, 20 to 80%, and is preferably 30 to 70%. The average pore size in the polyolefin porous film (or the porous polyolefin layer) may be selected from the range of 0.01 to 10 μm in view of ensuring both the ion conductivity and the mechanical strength, and is preferably 0.05 to 5 μm.

The porosity of the heat resistant porous film may be, for example, 20 to 70%, and is preferably 25 to 65%, in view of sufficiently ensuring the movability of lithium ions.

The separator may contain a commonly used additive (e.g., an antioxidant). The antioxidant may be contained either in the heat resistant porous film or in the polyolefin porous film. The antioxidant is, for example, at least one selected from the group consisting of a phenolic antioxidant, a phosphoric acid-series antioxidant, and a sulfur-containing antioxidant. For example, a phenolic antioxidant may be used in combination with a phosphoric acid-series antioxidant or a sulfur-containing antioxidant. A sulfur-containing antioxidant is highly compatible with polyolefin, and therefore, is preferably contained in the polyolefin porous film (e.g., a polypropylene porous film).

Examples of the phenolic antioxidant include hindered phenol compounds, such as 2,6-di-t-butyl-p-cresol, 2,6-di-t-butyl-4-ethylphenol, triethyleneglycol bis[3-(3-t-butyl-5-methyl-4-hydroxyphenyl)propionate], and n-octadecyl-3-(3,5-di-t-butyl-4-hydroxyphenyl)propionate. Examples of the sulfur-containing antioxidant include dilauryl thiodipropionate, distearyl thiodipropionate, and dimyristyl thiodipropionate. Preferred examples of the phosphoric acid-series antioxidant include tris(2,4-di-t-butylphenyl)phosphite.

(Non-Aqueous Electrolyte)

The non-aqueous electrolyte can be prepared by dissolving a lithium salt in a non-aqueous solvent. Examples of the non-aqueous solvent include: cyclic carbonates, such as ethylene carbonate, propylene carbonate, and butylene carbonate; chain carbonates, such as dimethyl carbonate and diethyl carbonate; lactones, such as γ-butyrolactone; halogenated alkanes, such as 1,2-dichloroethane; alkoxyalkanes, such as 1,2-dimethoxyethane and 1,3-dimethoxypropane; ketones, such as 4-methyl-2-pentanone; ethers, such as 1,4-dioxane, tetrahydrofuran, and 2-methyltetrahydrofuran; nitriles, such as acetonitrile, propionitrile, butyronitrile, valeronitrile, and benzonitrile; sulfolanes; 3-methyl-sulfolane; amides, such as dimethylformamide; sulfoxides, such as dimethylsulfoxide; and alkyl phosphate esters, such as trimethylphosphate and triethylphosphate. These non-aqueous solvents may be used singly or in combination of two or more.

Examples of the lithium salt include a lithium salt with strong electron-withdrawing ability, such as LiPF₆, LiBF₄, LiClO₄, LiAsF₆, LiCF₃SO₃ LiN(SO₂CF₃)₂LiN(SO₂C₂F₅)₂ and LiC(SO₂CF₃)₃. These lithium salts may be used singly or in combination of two or more. The concentration of the lithium salt in the non-aqueous electrolyte may be, for example, 0.5 to 1.5 M, and is preferably 0.7 to 1.2 M.

The non-aqueous electrolyte may further contain an additive, as needed. For example, in order to form a favorable surface film on the positive and negative electrodes, vinylene carbonate (VC), cyclohexylbenzene (CHB), or a modified form of VC or CHB may be added to the non-aqueous electrolyte. In order to reduce the harm that may occur when the lithium ion secondary battery is overcharged, for example, terphenyl, cyclohexylbenzene, or diphenyl ether may be added. These additives may be used singly or in combination of two or more. The ratio of the additive(s) is not particularly limited, but is, for example, about 0.05 to 10 wt % relative to the non-aqueous electrolyte.

The battery case may be, for example, a cylindrical or prismatic case with an open upper end, and is preferably made of, for example, an aluminum alloy containing a very small amount of metal such as manganese or copper, or an inexpensive nickel-plated steel sheet, in view of the pressure resistant strength.

The non-aqueous electrolyte secondary battery of the present invention can be used as, for example, a 18650 cylindrical battery.

### Embodiment 2

Description is given below of Embodiment 2 of the present invention. In the secondary battery of Embodiment 1, the reinforcing component 20 is provided on the outer peripheral side of the current collector. In a secondary battery of Embodiment 2, as illustrated in FIG. 5, disposed at the outermost periphery of the electrode group 14 is the separator 7. A reinforcing component 24 is provided on the outer peripheral side of the separator 7 at a position corresponding to the site facing the winding terminal end B of the positive electrode 5. By configuring like this, the portion of the negative electrode 6 where an electrode breakage is likely to occur can be effectively reinforced from outside. Therefore, an electrode breakage caused by changes in tension due to expansion and contraction of the electrodes can be effectively suppressed. At this time, it is preferable to use the aforementioned various heat resistant tapes as the reinforcing component 24.

Examples of the aforementioned Embodiments 1 and 2 are described below. It should be noted that the description here merely relates to illustrative examples of the present invention, and the present invention is not limited thereto.

### Example 1

### (1) Preparation of Positive Electrode 5

To an appropriate amount of N-methyl-2-pyrrolidone, 100 parts by weight of lithium cobalt oxide serving as the positive electrode active material, 2 parts by weight of acetylene black serving as the conductive agent, and 3 parts by weight of polyvinylidene fluoride resin serving as the binder were added and kneaded, to prepare a material mixture slurry in which these components were dispersed. The slurry was applied onto both surfaces of a belt-like aluminum foil (thickness: 15 μm) so as to form an unapplied portion at a predetermined position, and the applied slurry was dried. This was followed by rolling two to three times at a line pressure of 1000 kgf/cm (9.8 kN/cm), to adjust the total thickness to 180 μm. By cutting it into a size of 57 mm in width and 620 mm in length, a positive electrode 5 having positive electrode active material layers on its surfaces was obtained. The density of active material in the positive electrode active material layers was 3.6 g/ml.

To the exposed portion of the aluminum foil where no material mixture was applied, a positive electrode lead terminal 8 made of aluminum was ultrasonically welded. An electrically insulating tape made of polypropylene resin was stuck on the ultrasonically welded portion so as to cover the positive electrode lead terminal 8.

### (2) Preparation of Negative Electrode 6

To an appropriate amount of water, 100 parts by weight of flake graphite serving as the negative electrode active material, 1 part by weight (solid basis) of an aqueous dispersion of styrene-butadiene rubber (SBR) serving as the binder, and 1 part by weight of sodium carboxymethylcellulose serving as the thickener were added and kneaded for dispersing these components, to prepare a material mixture slurry. The slurry was applied onto both surfaces of a belt-like copper foil (thickness: 10 μm) so as to form an unapplied portion at a predetermined position, and the applied slurry was dried at 110° C. for 30 minutes. Specifically, an unapplied portion (an active-material-layer-free portion) was formed such that, as a result of the subsequent cutting process, the surface of the negative electrode current collector 6a on the outer peripheral side was to be exposed at the winding terminal end of the negative electrode 6 as shown in FIG. 2. To the site facing the winding terminal end B of the positive electrode 5 within the non-applied portion, the slurry was applied so that a negative electrode active material layer 6b serving as a reinforcing component 20 was partially formed.

This was followed by rolling two to three times at a line pressure of 110 kgf/cm (1.08 kN/cm), to adjust the total thickness to 174 μm. By cutting it into a size of 59 mm in width and 645 mm in length, a negative electrode 6 having negative electrode active materials on its surfaces was obtained. The density of active material in the negative electrode active material layers was 1.6 g/ml.

To the exposed portion of the copper foil where no material mixture was applied, a negative electrode lead terminal 10 made of nickel was resistance-welded. An electrically insulating tape made of polypropylene resin was stuck on the resistance-welded portion so as to cover the negative electrode lead terminal 10.

### (3) Preparation of Separator 7

A heat resistant composite film having a polyethylene layer and an aramid layer was prepared. Specifically, an N-methyl-2-pyrrolidone (NMP) solution of aramid containing calcium chloride was applied onto one surface of a polyethylene porous film (thickness: 16.5 μm) such that the total thickness reached 20 μm, and then dried. The resultant laminate was washed with water, to remove the calcium chloride therefrom, whereby micropores were formed in the aramid layer. This was followed by drying, to give a separator 7 being a heat resistant composite film. The resultant separator 7 was cut into a size of 60.9 mm in width, to be used for forming an electrode group.

The NMP solution of aramid had been prepared as follows. First, in a reaction bath, a predetermined amount of dry anhydrous calcium chloride was added to an appropriate amount of NMP, and heated to be dissolved completely. The calcium chloride-added NMP solution was brought back to room temperature, and then, a predetermined amount of paraphenylendiamin (PPD) was added thereto and dissolved completely. Subsequently, terephthalic acid dichloride (TPC) was slowly added thereto dropwise to allow polymerization reaction to proceed, thereby to synthesize polyparaphenylene terephthalamide (PPTA). Upon completion of the reaction, stirring was performed for 30 minutes under a reduced pressure to remove gas therefrom. The calcium chloride-added NMP solution was added again to the resultant polymerization solution to dilute it as appropriate, thereby to prepare an NMP solution of aramid resin.

### (4) Formation of Electrode Group 14

The positive electrode 5 and the negative electrode 6 were wound spirally with the separator 7 (in the form of a continuous sheet) interposed therebetween, to form an electrode group 14. Specifically, the positive electrode 5, the separator 7, the negative electrode 6, and another separator 7 were stacked in this order, with the longitudinal end portions of the two separators being extended from the positive and negative electrodes 5 and 6. The end portions of the separators 7 extended from one end are held between a pair of winding cores, and the separators were wound around the pair of winding cores serving as a winding axis, thereby to form a spirally-wound electrode group 14. At this time, the positive and negative electrodes 5 and 6 were wound such that the winding terminal end B of the positive electrode 5 faced the negative electrode 6 on the further outer peripheral side, with the separator 7 interposed therebetween. In addition, at the same time, the positive and negative electrodes 5 and 6 were wound such that the facing site of the negative electrode 6 where the negative electrode faced the winding terminal end B of the positive electrode 5 was reinforced with the negative electrode active material layer 6b which had been formed in advance as the reinforcing component 20, in the non-applied portion. Upon winding, the separator was cut, and the pair of winding cores was loosened and removed from the electrode group. In the electrode group, the length of the separator was 700 to 720 mm.

### (5) Fabrication of Non-Aqueous Electrolyte Secondary Battery

The electrode group 14 and a lower insulating plate 9 were placed in a battery case (diameter: 17.8 mm, overall height: 64.8 mm) 1 made of a metal obtained by press-molding a nickel-plated steel sheet (thickness: 0.20 mm). The lower insulating plate 9 was disposed between the bottom of the electrode group 14 and the negative electrode lead terminal 10 extended downward from the electrode group 14. The negative electrode lead terminal 10 was resistance-welded to the inner bottom surface of the battery case 1.

An upper insulating ring was mounted on the top of the electrode group 14 accommodated in the battery case 1, and a circumferential portion immediately above the upper insulating ring of the side wall of the battery case 1 was dented inwardly, to form an annular step portion. As a result, the electrode group 14 was held within the case 1.

A sealing plate 2 was laser-welded to the positive electrode lead terminal 8 extended upward from the battery case 1, and then a non-aqueous electrolyte was injected. The non-aqueous electrolyte had been prepared by dissolving LiPF₆ at a concentration of 1.0 M in a mixed solvent of ethylene carbonate (EC) and ethyl methyl carbonate (EMC) (volume ratio 2:1), and adding thereto cyclohexylbenzene in a ratio of 0.5% by weight.

Subsequently, the positive electrode lead terminal 8 was folded to be accommodated in the battery case 1. On the step portion, the sealing plate 2 provided with a gasket 13 around the periphery thereof was mounted. Thereafter, the opening end of the battery case 1 was clamped inwardly to seal the case. A cylindrical lithium ion secondary battery was thus produced. The battery was of 18650 type being 18.1 mm in diameter and 65.0 mm in height and had a nominal capacity of 2800 mAh. The number of the cylindrical lithium ion secondary batteries produced was 300.

### Example 2

Upon formation of the electrode group 14, in the negative electrode 6, an adhesive tape made of copper foil serving as the reinforcing component 20 was stuck on the outer peripheral side of the negative electrode collector 6a at a site facing the winding terminal end B of the positive electrode 5. The adhesive tape had a thickness of 100 μm, an adhesive strength of 9.8 N/25 mm, a tensile strength of 245 N/25 mm. A total of 300 non-aqueous electrolyte secondary batteries were produced in the same manner as in Example 1, except the above and that the negative electrode active material layer 6b serving as the reinforcing component 20 was not partially formed in the aforementioned non-applied portion.

### Example 3

In producing the negative electrode current collector 6a, the current density during electrodeposition on a rotation drum was adjusted, to produce an electrolytic copper foil provided with a thick portion. Specifically, a long electrolytic copper foil was continuously produced so that the total length of the 10-μm-thick portions became 635 mm, and the length of the 12-μm-thick portion became 10 mm. The negative electrode current collector 6a thus obtained was used to form the electrode group 14 such that the thick portion of the negative electrode current collector 6a, i.e., the reinforcing component 22, overlapped the site that faced the portion having a difference in thickness at the winding terminal end B of the positive electrode 5. A total of 300 non-aqueous electrolyte secondary batteries were produced in the same manner as in Example 1, except the above and that the negative electrode active material layer 6b serving as the reinforcing component 20 was not partially formed in the aforementioned non-applied portion.

### Example 4

The electrode group 14 was formed such that the separator 7 was placed at the outermost periphery as illustrated in FIG. 5, and an adhesive tape made of copper foil serving as a reinforcing component 24 was stuck at the position corresponding to the site facing the winding terminal end B of the positive electrode 5. The adhesive tape used here was the same as used in Example 2. A total of 300 non-aqueous electrolyte secondary batteries were produced in the same manner as in Example 1, except the above and that the negative electrode active material layer 6b serving as the reinforcing component 20 was not partially formed in the aforementioned non-applied portion.

### Comparative Example 1

A total of 300 non-aqueous electrolyte secondary batteries were produced in the same manner as in Example 1, except that a component corresponding to the reinforcing component 20 as provided in Examples 1 to 4 was not provided.

The non-aqueous electrolyte secondary batteries of Examples and Comparative Example were subjected to a charge/discharge test, for evaluating the charge/discharge characteristics thereof.

The charge/discharge test was performed in a 45° C. constant temperature bath under the following settings: charge rate 0.8 C, discharge rate 1 C, charge cut-off voltage 4.2 V, discharge cut-off voltage 3 V, and rest time 30 min, and the discharge capacity was measured per cycle. In the charge/discharge test, 500 charge/discharge cycles were performed. The average of the capacity retention rates of the batteries after 500 charge/discharge cycles relative to their initial capacities was calculated. The results are shown in Table 1.

TABLE 1

| | | Capacity | Occurrence rate of |
|---|---|---|---|
| | | retention | sharp drop in |
| | Reinforcing component | rate (%) | capacity |
| Ex. 1 | Active material layer | 84.3 | 0 |
| | (Material mixture layer) | | (0/300 batteries) |
| Ex. 2 | Adhesive tape made of copper | 82.5 | 0 |
| | foil | | (0/300 batteries) |
| Ex. 3 | Thick portion of current | 85.0 | 0 |
| | collector | | (0/300 batteries) |
| Ex. 4 | Adhesive tape made of copper | 83.6 | 0 |
| | foil on outer peripheral | | (0/300 batteries) |
| | side of separator | | |
| Com. | None | 65.2 | 13% |
| Ex. 1 | | | (39/300 batteries) |

In Examples 1 to 4, no batteries exhibited sharp drop in capacity during 500 charge/discharge cycles. After the completion of 500 charge/discharge cycles, the batteries were disassembled and checked. No electrode breakage was observed in any of the batteries.

In contrast, in Comparative Example 1, 39 out of 300 batteries exhibited sharp drop in capacity, within 200 cycles. These batteries were disassembled and checked. In all of the batteries checked, an electrode breakage occurred in the negative electrode at the outermost periphery of the electrode group, at the site facing the winding terminal end of the positive electrode, and the broken portion was completely severed. Of the batteries in which no sharp drop in capacity was observed after the completion of 500 charge/discharge cycles, 10 batteries were disassembled to observe the electrode. As a result, a partial electrode breakage was observed in all of the batteries checked, although the electrode was not severed completely.

The foregoing results show that the breakage of the negative electrode at the outermost periphery of the electrode group during repetitive charge and discharge can be suppressed by reinforcing the strength of the negative electrode positioned on the outer peripheral side of the winding terminal end B of the positive electrode. The capacity retention rate differed among Examples 1 to 4. This is presumably because the difference in the reinforcing method resulted in the difference in the effect. It is to be noted, however, that as a result of disassembling and observing the batteries of each Example, no electrode breakage was observed at all. Presumably, there was a subtle change in the visually unobservable metal morphology in the copper-foil current collector, and this resulted in the difference in capacity retention rate.

Although in the above Examples, the negative electrode was arranged at the outermost periphery, the positive electrode can be arranged at the outermost periphery with similar effects on the breakage of the positive electrode arranged at the outermost periphery, by employing a similar configuration.

### Embodiment 3

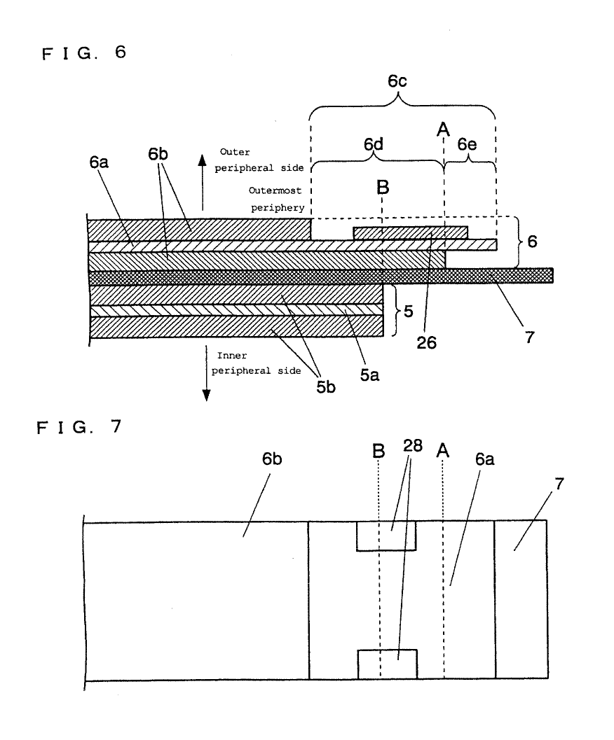

FIG. 6 is a partial cross-sectional view of an electrode group of a non-aqueous electrolyte secondary battery according to Embodiment 3 of the present invention. In the non-aqueous electrolyte secondary battery as illustrated, a reinforcing component 26 is provided in an active-material-layer-free portion 6c, on a predetermined area (boundary area) including a boundary A between a one-surface active-material-layer-free portion 6d where the negative electrode active material layer 6b is not formed only on a surface on the outer peripheral side of the negative electrode current collector 6a, and a both-surface active-material-layer-free portion 6e where the negative electrode active material layer 6b is not formed on both surfaces of the negative electrode current collector 6a. As a result, even when the negative electrode 6 continuously undergoes great changes in tension due to the overcharged state, the strength of the electrode can be ensured, and the occurrence of burrs caused by an electrode breakage can be suppressed. This can prevent abnormal overheating of the battery resulted from internal short-circuiting. The reinforcing component 26 may be provided on the inner peripheral side of the negative electrode 6; however, by providing it on the outer peripheral side of the negative electrode 6 where the negative electrode current collector 6a is exposed, the negative electrode 6 can be more effectively reinforced.

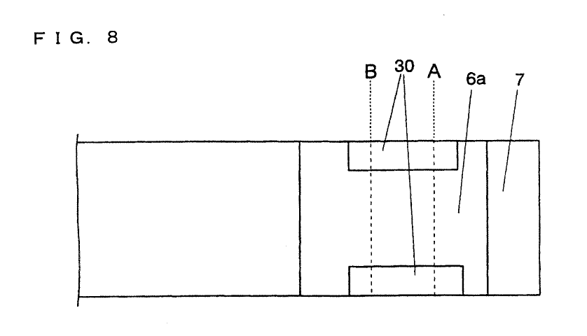

In the above Embodiments 1 to 3, the reinforcing component may be provided on at least one widthwise end portion of the belt-like electrode, as shown in FIGS. 7 and 8. For example, as shown in FIG. 7, a reinforcing component 28 similar to that in Embodiments 1 and 2 may be provided only on widthwise end portions of the negative electrode 6. Alternatively, as shown in FIG. 8, a reinforcing component 30 similar to that in Embodiment 3 may be provided only on widthwise end portions of the negative electrode 6. An electrode breakage tends to occur starting from a widthwise end portion. Therefore, simply by providing a reinforcing component on a widthwise end portion of the electrode, an electrode breakage can be effectively prevented. It is to be noted that if an electrode breakage is more likely to occur in one of both widthwise end portions than the other, the reinforcing component can be provided only on one end portion in which an electrode breakage is more likely to occur.

An Example of the aforementioned Embodiment 3 is described below. It should be noted that the description here merely relates to an illustrative example of the present invention, and the present invention is not limited thereto.

### Example 5

An electrode group was formed in the same manner as in Example 1, except that the negative electrode active material layer 6b serving as the reinforcing component 20 was not partially formed in the aforementioned non-applied portion. Thereafter, in the negative electrode 6 at the outermost periphery, a 30-μm-thick polypropylene tape was stuck so as to overlap a site (boundary area) corresponding to the boundary A between the one-surface active-material-layer-free portion and the both-surface active-material-layer-free portion of the negative electrode current collector 6a, and a site facing the winding terminal end B of the positive electrode 5. The negative electrode 6 was reinforced in such a manner. The length of the polypropylene tape used was 3 cm. A total of 10 non-aqueous electrolyte secondary batteries were produced in the same manner as in Example 1, except the above.

### Comparative Example 2

A total of 10 non-aqueous electrolyte secondary batteries were produced in the same manner as in Example 5, except that the reinforcing component 30 overlapping the boundary A and the winding terminal end B as provided in Example 5 was not provided.

The non-aqueous electrolyte secondary batteries of Example 5 and Comparative Example 2 were subjected to a overcharge test.

### <Overcharge Test>

In the overcharge test, charging was performed at a charge current of 2.1 C (5.9 A) for 1 hour in a 25° C. environment, and the number of batteries from which smoke occurred due to abnormal overheating of the battery was counted, to calculate the occurrence rate. The evaluation results are shown in Table 2.

TABLE 2

| | Reinforcing | Occurrence rate of |
|---|---|---|
| | component | smoke |
| Ex. 5 | Polypropylene tape | 0 (0/10 batteries) |
| Com. Ex. 2 | None | 40% (4/10 batteries) |

In Example 5, no smoke occurred from any of the batteries during the overheat test. After the completion of the overcharge test, the batteries were disassembled and checked. No electrode breakage was observed.

In contrast, in Comparative Example 2, smoke occurred from four out of ten batteries during the overcharge test. The other batteries from which no smoke occurred were disassembled and checked. In all of the batteries checked, a partial breakage was observed at the boundary between the one-surface active-material-layer-free portion and the both-surface active-material-layer-free portion in the negative electrode at the outermost periphery. It is presumed, therefore, that in the four batteries from which smoke occurred, burrs were formed due to the breakage of the electrode, which caused internal short circuits, and consequently, smoke occurred.

Although in the above Example, the negative electrode was arranged at the outermost periphery, the positive electrode can be arranged at the outermost periphery with similar effects on the breakage of the positive electrode arranged at the outermost periphery, by employing a similar configuration.

### INDUSTRIAL APPLICABILITY

The battery of the present invention is particularly useful for a lithium ion secondary battery including a wound electrode group with an improved energy density, for example, with a higher density of the positive and negative electrode active materials.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

1 . . . Battery case
2 . . . Sealing plate
5 . . . Positive electrode
5a . . . Positive electrode current collector
5b . . . Positive electrode active material layer
6 . . . Negative electrode
6a . . . Negative electrode current collector
6b . . . Negative electrode active material layer
7 . . . Separator
14 . . . Electrode group
20, 22, 24, 26, 28, 30 . . . Reinforcing component

1. A non-aqueous electrolyte secondary battery comprising: a spirally-wound electrode group including a continuous first electrode, a continuous second electrode, and a continuous separator interposed between the first electrode and the second electrode; and a non-aqueous electrolyte, wherein
the first electrode includes a sheet-like first current collector, and a first active material layer formed on a surface of the first current collector;
the second electrode includes a sheet-like second current collector, and a second active material layer formed on a surface of the second current collector;
a winding terminal end of the first electrode faces the second electrode on the further outer peripheral side, with the separator interposed therebetween;
a facing site of the second electrode where the second electrode faces the winding terminal end of the first electrode is reinforced with a reinforcing component for supplementing a thickness of the second electrode;
the facing site is an active-material-layer-formed portion where the second active material layer is formed at least on the outer peripheral side; and
the active-material-layer-formed portion is present between the active-material-layer-free portions where the second active material layer is not formed at least on the outer peripheral side, and the second active material layer formed on the outer peripheral side of the active-material-layer-formed portion comprises the reinforcing component.

2. A non-aqueous electrolyte secondary battery comprising: a spirally-wound electrode group including a continuous first electrode, a continuous second electrode, and a continuous separator interposed between the first electrode and the second electrode; and a non-aqueous electrolyte, wherein
the first electrode includes a sheet-like first current collector, and a first active material layer formed on a surface of the first current collector;
the second electrode includes a sheet-like second current collector, and a second active material layer formed on a surface of the second current collector;
a winding terminal end of the first electrode faces the second electrode on the further outer peripheral side, with the separator interposed therebetween;
a facing site of the second electrode where the second electrode faces the winding terminal end of the first electrode is reinforced with a reinforcing component for supplementing a thickness of the second electrode; and
the reinforcing component is a thick portion where the thickness of the second current collector is partially increased.

3. A non-aqueous electrolyte secondary battery comprising: a spirally-wound electrode group including a continuous first electrode, a continuous second electrode, and a continuous separator interposed between the first electrode and the second electrode; and a non-aqueous electrolyte, wherein
the first electrode includes a sheet-like first current collector, and a first active material layer formed on a surface of the first current collector;
the second electrode includes a sheet-like second current collector, and a second active material layer formed on a surface of the second current collector;
a winding terminal end of the first electrode faces the second electrode on the further outer peripheral side, with the separator interposed therebetween;
a facing site of the second electrode where the second electrode faces the winding terminal end of the first electrode is reinforced with a reinforcing component for supplementing a thickness of the second electrode;
the separator is arranged on the further outer peripheral side of the facing site; and
the reinforcing component is provided on the outer peripheral side of the separator at the portion facing the facing site.

4. The non-aqueous electrolyte secondary battery in accordance with claim 2, wherein the facing site is an active-material-layer-free portion where the second active material layer is not formed at least on the outer peripheral side.

5. The non-aqueous electrolyte secondary battery in accordance with claim 2, wherein the reinforcing component is provided on the outer peripheral side of the facing site.

6. The non-aqueous electrolyte secondary battery in accordance with claim 3, wherein the reinforcing component is a tape including a base sheet and an adhesive provided on at least one surface of the base sheet.

7. The non-aqueous electrolyte secondary battery in accordance with claim 6, wherein the base sheet is heat resistant and is resistant to denaturation at 120° C.

8. The non-aqueous electrolyte secondary battery in accordance with claim 6, wherein the base sheet includes a metal foil.

9. The non-aqueous electrolyte secondary battery in accordance with claim 8, wherein the second current collector is made of the same material as the metal foil.

10. The non-aqueous electrolyte secondary battery in accordance with claim 1, wherein
the second electrode includes a one-surface active-material-layer-free portion where the second active material layer is not formed on the outer peripheral side, and a both-surface active-material-layer-free portion where the second active material layer is not formed both on the outer peripheral side and on the inner peripheral side, the both-surface active-material-layer-free portion being adjacent to the one-surface active-material-layer-free portion; and
the reinforcing component reinforces also a boundary between the one-surface active-material-layer-free portion and the both-surface active-material-layer-free portion.

11. The non-aqueous electrolyte secondary battery in accordance with claim 1, wherein the reinforcing component is provided on at least one widthwise end portion of the second electrode.

12. A method for producing a non-aqueous electrolyte secondary battery, the method comprising the steps of:
(a) preparing a continuous first electrode including a sheet-like first current collector, and a first active material layer formed on a surface of the first current collector;
(b) preparing a continuous second electrode including a sheet-like second current collector, and a second active material layer formed on a surface of the second current collector; and
(c) spirally winding the first electrode and the second electrode, with a continuous separator interposed therebetween, thereby to form an electrode group, wherein
the first electrode and the second electrode are wound such that a winding terminal end of the first electrode faces the second electrode on the further outer peripheral side, with the separator interposed therebetween,
a facing site of the second electrode where the second electrode faces the winding terminal end of the first electrode is reinforced in advance with a reinforcing component for supplementing a thickness of the second electrode,
the facing site is an active-material-layer-formed portion where the second active material layer is formed at least on the outer peripheral side, and
the active-material-layer-formed portion is present between the active-material-layer-free portions where the second active material layer is not formed at least on the outer peripheral side, and the second active material layer formed on the outer peripheral side of the active-material-layer-formed portion comprises the reinforcing component.

13. A method for producing a non-aqueous electrolyte secondary battery, the method comprising the steps of:
(a) preparing a continuous first electrode including a sheet-like first current collector, and a first active material layer formed on a surface of the first current collector;
(b) preparing a continuous second electrode including a sheet-like second current collector, and a second active material layer formed on a surface of the second current collector; and
(c) spirally winding the first electrode and the second electrode, with a continuous separator interposed therebetween, thereby to form an electrode group, wherein the first electrode and the second electrode are wound such that a winding terminal end of the first electrode faces the second electrode on the further outer peripheral side, with the separator interposed therebetween,
a facing site of the second electrode where the second electrode faces the winding terminal end of the first electrode is reinforced in advance with a reinforcing component for supplementing a thickness of the second electrode, and
the reinforcing component is a thick portion where the thickness of the second current collector is partially increased.

14. A method for producing a non-aqueous electrolyte secondary battery, the method comprising the steps of:
(a) preparing a continuous first electrode including a sheet-like first current collector, and a first active material layer formed on a surface of the first current collector;
(b) preparing a continuous second electrode including a sheet-like second current collector, and a second active material layer formed on a surface of the second current collector; and
(c) spirally winding the first electrode and the second electrode, with a continuous separator interposed therebetween, thereby to form an electrode group, wherein
the first electrode and the second electrode are wound such that a winding terminal end of the first electrode faces the second electrode on the further outer peripheral side, with the separator interposed therebetween,
a facing site of the second electrode where the second electrode faces the winding terminal end of the first electrode is reinforced in advance with a reinforcing component for supplementing a thickness of the second electrode,
the separator is arranged on the further outer peripheral side of the facing site, and
the reinforcing component is provided on the outer peripheral side of the separator at the portion corresponding to the facing site.

15. (canceled)

16. (canceled)

17. The non-aqueous electrolyte secondary battery in accordance with claim 3, wherein the facing site is an active-material-layer-free portion where the second active material layer is not formed at least on the outer peripheral side.

18. The non-aqueous electrolyte secondary battery in accordance with claim 2, wherein
the second electrode includes a one-surface active-material-layer-free portion where the second active material layer is not formed on the outer peripheral side, and a both-surface active-material-layer-free portion where the second active material layer is not formed both on the outer peripheral side and on the inner peripheral side, the both-surface active-material-layer-free portion being adjacent to the one-surface active-material-layer-free portion; and
the reinforcing component reinforces also a boundary between the one-surface active-material-layer-free portion and the both-surface active-material-layer-free portion.

19. The non-aqueous electrolyte secondary battery in accordance with claim 3, wherein
the second electrode includes a one-surface active-material-layer-free portion where the second active material layer is not formed on the outer peripheral side, and a both-surface active-material-layer-free portion where the second active material layer is not formed both on the outer peripheral side and on the inner peripheral side, the both-surface active-material-layer-free portion being adjacent to the one-surface active-material-layer-free portion; and
the reinforcing component reinforces also a boundary between the one-surface active-material-layer-free portion and the both-surface active-material-layer-free portion.

20. The non-aqueous electrolyte secondary battery in accordance with claim 2, wherein the reinforcing component is provided on at least one widthwise end portion of the second electrode.

21. The non-aqueous electrolyte secondary battery in accordance with claim 3, wherein the reinforcing component is provided on at least one widthwise end portion of the second electrode.
